(19) United States
(12) Patent Application Publication
(10) Pub. No.: US 2006/0098239 A1
(43) Pub. Date: May 11, 2006

(54) Image acquiring device with background filtering function

(75) Inventors: Yu-Lang Wang, Jhubei City (TW); Ting-Kuo Chu, Jhubei City (TW)

Correspondence Address: BIRCH STEWART KOLASCH & BIRCH, PO BOX 747, FALLS CHURCH, VA, 22040-0747, US

(73) Assignee: Avision Inc.

(21) Appl. No.: 11/267,273

(22) Filed: Nov. 7, 2005

(30) Foreign Application Priority Data
Nov. 8, 2004 (TW) 093133999

(51) Int. Cl. H04N 1/40

(52) U.S. Cl. 358/448

(57) ABSTRACT

An image acquiring device with background filtering function includes a scanning module, a color splitting module and an image processing module. The scanning module includes a CCD sensor for sensing a document image signal travelling along an optical path. The CCD sensor has red, green, blue and white light sensing member sets. A data transmission speed of the white light sensing member set is greater than that of each of the red, green and blue light sensing member sets. The color splitting module disposed on the optical path only lets one of red, green and blue light pass through at a time under a filtering mode. The white light sensing member set receives the red, green or blue light outputted from the color splitting module. Then, the image processing module recognizes a brightness value of a pixel, which exceeds a predetermined value, and compensates for the brightness value of this pixel to generate a brightness value corresponding to a white.

### BACKGROUND OF THE INVENTION

1. Field of the Invention

The invention relates to an image acquiring device with background filtering function, and more particularly to an image acquiring device using a color splitting module in conjunction with a white light sensing member set having a high data transmission speed to assist in background filtering.

2. Description of the Related Art

A conventional color splitting device, such as that disclosed in the commonly assigned Taiwan Patent Publication No. 186937, is used to obtain a color scan result in conjunction with a white sensing member. In operation, a motor of the color splitting device rotates a shaft having an outer circumferential surface, to which a red filter, a green filter, a blue filter and a transparent sheet are attached. The three filters only let red (R), green (G) and blue (B) light pass through, respectively, such that the white light sensing members sense three primary colors (red, green and blue) of image data. Then, a processor processes the three primary colors of the image data into a color image data.

However, because the image sensor technology is rapidly developed, the current image sensor contains red, green, blue and white light sensing members. When the color scan is performed, the red, green and blue light sensing members respectively capture red, green and blue image data. Thus, the current image acquiring device, such as a scanner, does not need the color splitting device any more to perform the color scan operation.

Background filtering is necessary to the process of scanning a document with a colored background or a colored mark. If the document is scanned in a gray mode without background filtering, the scanned result may become a gray image because the colored background may blur the texts on the document, or the scanned result may become a partially black image because the colored mark may partially blur the texts on the document. Thus, the gray image cannot be used in an optical character recognition (OCR) process. If the document is scanned in a black and white mode without background filtering, the scanned result may become a fully black image because the colored background may shield the texts on the document, or the scanned result may become a partially black image because the colored mark may partially shield the texts on the document.

Background filtering may be used in various applications. For example, if the background of the document is red, the user may want to remove the gray background, which corresponds to the red background of the document generated after the scanner scans the document in the gray mode, from the scanned result, such that the scanned result can be printed in a black and white mode without wasting too much printing material. In addition, if the document with a white background has been kept form a long time and has thus yellowed, the user may want to remove the gray background, which corresponds to the yellow background of the document generated after the scanner scans the document in the gray mode, from the scanned result. Furthermore, if the document has been sealed by a blue/red seal, the user may want to remove the image, which corresponds to the sealed image of the document, from the scanned result such that the scanned result can be precisely processed by the optical character recognition (OCR) software. When the background has to be filtered out, the conventional method uses the red, green or blue light sensing members to scan the image data, and then an image processor to compensate for the scanned image data. For example, if the background of the document is close to red, the red light sensing members may be used to scan the document. Consequently, the brightness values of the pixels in the image data of the red background are inevitably higher than a specific value, such as 200 between 0 to 255, and the image data which does not correspond to the red color is converted into a gray-scale image data. Thus, the brightness values of the pixels exceeding the specific value (e.g., 200) are directly converted into 255, which corresponds to the brightest white, and the red background may be effectively filtered out such that the gray-scale image data is obtained.

In the current trend, the charge coupled device (CCD) image sensor presently used in the document scanner includes 4 channels of light sensing members, i.e., red (R), green (G), blue (B) and white (W) light sensing members, wherein the white (W) light sensing members can sense the true gray image. However, the document scanner, particularly the document scanner suitable for the office, often uses the white light sensing members but not the R, G, or B light sensing members to scan the document. This is because the object of scanning the documents in the office is to backup or file the documents. In order to satisfy the quick backup and filing requirements, the data transmission speeds of the current white light sensing members are usually higher than those of the R, G and B light sensing members. For example, it is possible to utilize a sensor having two shift registers for outputting image data at two sides such that the requirement of quickly outputting data may be satisfied.

If a background filtering operation has to be performed in the above-mentioned document scanner, the image signal is obtained using the R, G or B light sensing members. So, the image data sensing speed is relatively slow, and the requirement of quickly removing the background to obtain the gray-scale image data cannot be satisfied.

### SUMMARY OF THE INVENTION

It is therefore an object of the invention to provide an image acquiring device capable of filtering a background using a color splitting module and a white light sensing member set having a high data transmission speed.

To achieve the above-identified object, the invention provides an image acquiring device including a scanning module, a color splitting module and an image processing module. The scanning module includes a charge coupled device (CCD) sensor for sensing an image signal of a to-be-scanned document travelling along an optical path. The CCD sensor has red (R), green (G), blue (B) and white (W) light sensing member sets for sensing red, green, blue and white light, respectively. A data transmission speed of the white light sensing member set is higher than that of each of the R, G and B light sensing member sets. The color splitting module disposed on the optical path only lets one of the red, green and blue light pass through at a time under a filtering mode, and lets the red, green and blue light pass through directly under a non-filtering mode. The image processing module processes the image signal. The red, green or blue light outputted from the color splitting module is received by the white light sensing member set. The image processing module recognizes a brightness value of a pixel, which exceeds a predetermined value, and compensates for the brightness value of the pixel to generate a specific brightness value so as to change a background color of the to-be-scanned document quickly.

The color splitting module may be composed of a red filter, a green filter and a blue filter, which are attached to a shaft, and a motor for rotating the shaft. Alternatively, the color splitting module may be composed of a color wheel and a motor for rotating the color wheel.

### BRIEF DESCRIPTION OF THE DRAWINGS

FIG. 1 is a schematic illustration showing an image acquiring device with background filtering function according to a first embodiment of the invention.

FIG. 2 is a schematic illustration showing an image acquiring device with background filtering function according to a second embodiment of the invention.

### DETAILED DESCRIPTION OF THE INVENTION

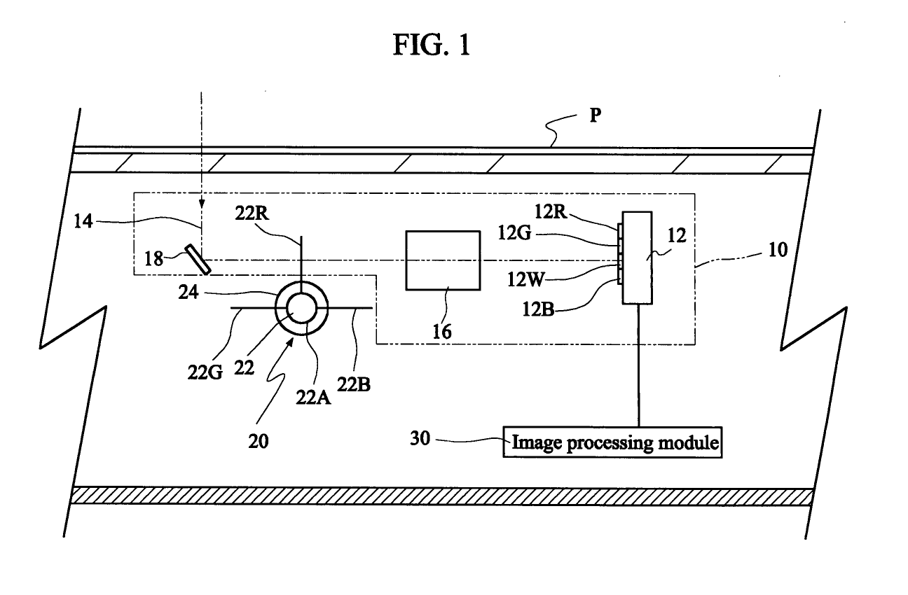

FIG. 1 is a schematic illustration showing an image acquiring device with background filtering function according to a first embodiment of the invention. Referring to FIG. 1, the image acquiring device of this embodiment includes a scanning module 10, a color splitting module 20 and an image processing module 30. The scanning module 10 includes a CCD sensor 12, a lens 16 and a reflecting mirror 18. The CCD sensor 12 senses an image signal of a to-be-scanned document P travelling along an optical path 14. The lens 16 focuses light rays onto the CCD sensor 12. The reflecting mirror 18, which is an essential part in the design of the optical path, reflects the light rays. The CCD sensor 12 has red (R), green (G), blue (B) and white (W) light sensing member sets 12R, 12G, 12B and 12W for respectively sensing red, green, blue and white light. A data transmission speed of the white sensing member set 12W is higher than that of each of the light sensing member sets 12R, 12G and 12B, which is the trend in designing the current document scanner such that the speed of scanning the document in the black-and-white mode or the gray-scale mode may be maximized.

The color splitting module 20 disposed on the optical path 14 only lets one of the red, green and blue light pass through at a time under a filtering mode, and lets the red, green and blue light pass through directly at a time under a non-filtering mode. That is, the user may select the filtering mode by selecting the background filtering scan operation, and the non-filtering mode by selecting the typical black-and-white, gray-scale or color scan operation.

The color splitting module 20 includes a shaft 22 and a motor 24. The axis of the shaft 22 is perpendicular to the optical path 14 when viewed from a top of the document to a bottom of the document. The shaft 22 has a circumferential surface 22A, on which a red filter 22R, a green filter 22G and a blue filter 22B extending radially from the shaft are disposed. The motor 24 rotates the shaft 22. In this embodiment, an angle between the filters 22R and 22G is 90 degrees, an angle between the filters 22R and 22B is 90 degrees, and an angle between the filters 22G and 22B is 180 degrees. Thus, the shaft 22 in the state of FIG. 1 only has to be rotated by 180 degrees under the non-filtering mode. Consequently, the shaft 22 is rotated such that one of the red filter 22R, the green filter 22G and the blue filter 22B is located on the optical path 14, and is then stopped such that the scanning module 10 scans the to-be-scanned document P.

The image processing module 30 processes the image signal. The red, green or blue light outputted from the color splitting module 20 is received by the white sensing member set 12W. Then, the image processing module 30 recognizes a brightness value of a pixel exceeding a predetermined value, such as 200, and converts the brightness value of the pixel into a brightness value (e.g., 255) corresponding to a white, a brightness value (e.g., 0) corresponding to a black or a specific brightness value (e.g., 120) corresponding to a specific gray. Thus, the background color of the to-be-scanned document P may be quickly filtered out or replaced with a new one.

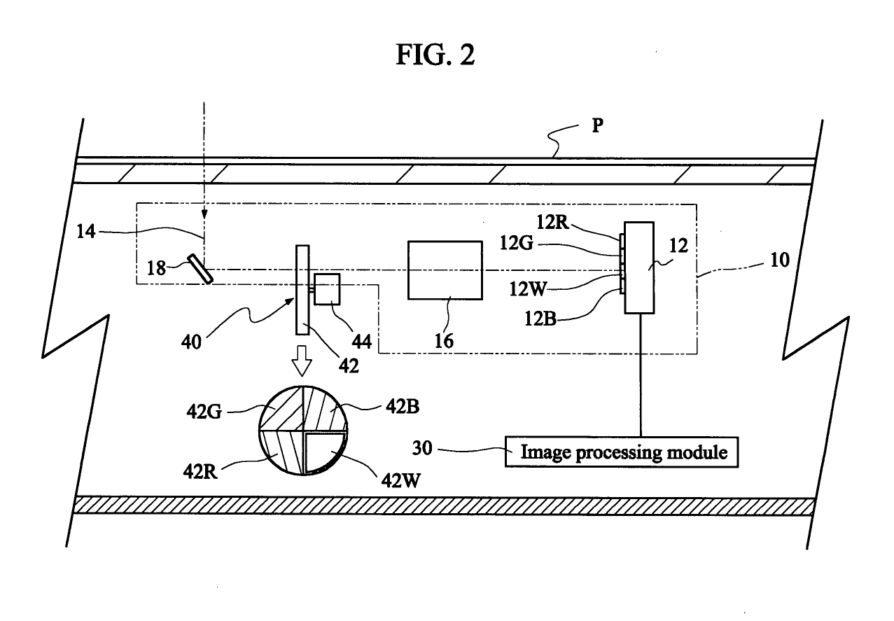

FIG. 2 is a schematic illustration showing an image acquiring device with background filtering function according to a second embodiment of the invention. As shown in FIG. 2, this embodiment is similar to the first embodiment except that a color splitting module 40 has another structure different from that of the color splitting module 20. Detailed descriptions about the similar parts are the same as those of the first embodiment will be omitted. The color splitting module 40 includes a wheel 42 and a motor 44. The axis of the wheel 42 is parallel to the optical path 14.

The wheel (also referred to as a color wheel) 42 has a red filter 42R, a green filter 42G, a blue filter 42B and a light penetrating portion 42W. The motor 44 rotates the wheel 42. The wheel 42 is rotated such that one of the red filter 42R, the green filter 42G and the blue filter 42B is located on the optical path 14, and is then stopped such that the scanning module 10 scans the to-be-scanned document P. The light penetrating portion 42W may be a notch or a transparent sheet. Usually, the wheel 42 may be a transparent wheel on which red, green and blue paints are painted.

Although the embodiments are described in terms of the flatbed scanner, the invention may also be applied to a sheet-fed scanner, a scanner for scanning a reflective original and a transparency scanner. According to the image acquiring device of the invention, the high speed background filtering operation may be performed while complying with the design trend of the current document scanner. Thus, the invention can provide a high-speed background filtering operation while satisfying the quick document scanning operations in the black-and-white or the gray-scale mode, and thus satisfy the user's requirement.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. An image acquiring device, comprising:
a scanning module comprising a charge coupled device (CCD) sensor for sensing an image signal of a to-be-scanned document travelling along an optical path, wherein the CCD sensor has red (R), green (G), blue (B) and white (W) light sensing member sets for sensing red, green, blue and white light, respectively, and a data transmission speed of the white light sensing member set is higher than that of each of the R, G and B light sensing member sets;
a color splitting module, which is disposed on the optical path, for only letting one of the red, green and blue light pass through at a time under a filtering mode, and for letting the red, green and blue light pass through directly under a non-filtering mode; and
an image processing module for processing the image signal, wherein the red, green or blue light outputted from the color splitting module is received by the white light sensing member set, and the image processing module recognizes a brightness value of a pixel, which exceeds a predetermined value, and compensates for the brightness value of the pixel to generate a specific brightness value so as to change a background color of the to-be-scanned document quickly.

2. The device according to claim 1, wherein the color splitting module comprises:
a shaft having a circumferential surface, on which a red filter, a green filter and a blue filter are disposed; and
a motor for rotating the shaft, wherein the shaft is rotated such that one of the red filter, the green filter and the blue filter is located on the optical path, and then the shaft is stopped such that the scanning module scans the to-be-scanned document.

3. The device according to claim 1, wherein the color splitting module comprises:
a wheel, on which a red filter, a green filter, a blue filter and a light penetrating portion are attached; and
a motor for rotating the wheel, wherein the wheel is rotated such that one of the red filter, the green filter and the blue filter is located on the optical path, and is then stopped such that the scanning module scans the to-be-scanned document.

4. The device according to claim 3, wherein the light penetrating portion is a notch.

5. The device according to claim 3, wherein the light penetrating portion is a transparent sheet.

6. The device according to claim 1, wherein the specific brightness value corresponds to a brightness value of a white.

7. The device according to claim 1, wherein the specific brightness value corresponds to a brightness value of a black.
